(19) United States
(12) Patent Application Publication
(10) Pub. No.: US 2016/0224944 A1
(43) Pub. Date: Aug. 4, 2016

(54) SYSTEMS AND METHODS FOR EVENT SCHEDULING

(71) Applicant: Ravinder Singh TOOR, Coquitlam (CA)

(72) Inventor: Ravinder Singh TOOR, Coquitlam (CA)

(21) Appl. No.: 14/609,280

(22) Filed: Jan. 29, 2015

(51) Int. Cl. G06Q 10/10

(52) U.S. Cl. CPC G06Q 10/1095

(57) ABSTRACT

Systems and methods are provided to incentivize early registration for events to facilitate scheduling of sub-events within the event by allowing event participants, in order of registration, to select and fix sub-event variables preferred by the event participants.

### TECHNICAL FIELD

This invention relates to systems and methods for event scheduling.

### BACKGROUND

Last-minute registration is a problem for event organizers of events such as sports tournaments and sports league seasons. The vast majority of participants typically register at the last minute. Not knowing the number and profile of participants well in advance of the event can make it challenging to schedule and book individual sub-events (e.g. matches) within the event (e.g. tournament or league season).

Known approaches to mitigating the problem of last-minute registrations have drawbacks. Setting an early deadline can limit the number of participants by excluding potential participants who cannot commit to participating in the event by the early deadline. Offering “early bird” discounts to incentivize early registration can decrease revenue for event organizers.

Improved systems and methods for event scheduling are desirable.

### SUMMARY

The invention described herein has many aspects.

In one aspect, a system for event scheduling is provided. The system comprises a server, a plurality of event participant computers, and an event scheduler computer. The server is configured to:
send a registration application for an event to an event participant computer upon receiving a request from the event participant computer;
determine whether a completed registration application received from the event participant computer is valid;
generate an event registration queue order comprising a list of identifiers for event participants with valid completed registration applications, in temporal order of receipt of the completed registration application;
record selected sub-event variables of each event participant in the order of the event registration queue order; and
automatically update available sub-event variables to the next event participant in the event registration queue order after recordal of each event participant's selected sub-event variables.
   The plurality of event participant computers is configured to:
allow event participants to complete and send the registration applications to the server; and
allow the event participants to select sub-event variables.
   The event scheduler computer is configured to allow an event scheduler to define and send sub-event variables to the server.

The system may comprise a registrar computer configured to allow a registrar to create and send the registration application to the server. The event scheduler computer or the registrar computer may be further configured to allow the event scheduler or registrar to associate a premium fee with a sub-event variable, and to send information associating the premium fee with the sub-event variable to the server; wherein the server may be configured to send information associating the premium fee with the sub-event variable to the event participant computer; wherein the plurality of event participant computers may be configured to allow the event participants to select the sub-event variable associated with the premium fee; and wherein the server may be configured to record the selected sub-event variable associated the premium fee.

The event scheduler computer or the registrar computer may be further configured to allow the event scheduler or registrar to associate a first premium fee with a first sub-event variable, and a second premium fee with a second sub-event variable, wherein the first premium fee and the second premium fee are not equal.

The registrar computer and the event scheduler computer may be the same computer.

The server may be configured to receive from the event participant computer of a next event participant in the event registration queue order the next event participant's selection of the sub-event variable if the a current event participant does not make the current event participant's selection of the sub-event variable within a predetermined time limit.

The server may be configured to send information identifying sub-event variable selections made by event participants to the event participant computer of event participants yet to make sub-event variable selections. The server may be configured to block information identifying sub-event variable selections made by event participants from being sent to event participant computers of event participants yet to make sub-event variable selections.

The event participant computer may be configured to allow a sub-event variable selection change to the server, wherein server is configured to receive the sub-event variable selection change from the event participant computer and to either accept or reject the sub-event variable selection change based on whether the sub-event variable selection change is possible in view of the remaining sub-event variables.

One or more of the event scheduler computer, the registrar computer and the server may be configured to define access rights of event participants, and wherein the server is configured to base the sub-event variables to displayed on the event participant computers on the access right of a particular event participant. The access rights of event participants may be defined based on or more of the event participant's previous event participation history, premium fee payment, ranking, skill category, age category and sex.

The foregoing discussion merely summarizes certain aspects of the invention and is not intended, nor should it be construed, as limiting the invention in any way.

### BRIEF DESCRIPTION OF DRAWINGS

The accompanying drawings illustrate non-limiting example embodiments of the invention.

FIG. 1 is a block process diagram depicting an event scheduling method according to an embodiment;

FIG. 2 is a block process diagram depicting an event scheduling method according to an embodiment; and

FIG. 3 is a schematic diagram of an event scheduling system according to an embodiment.

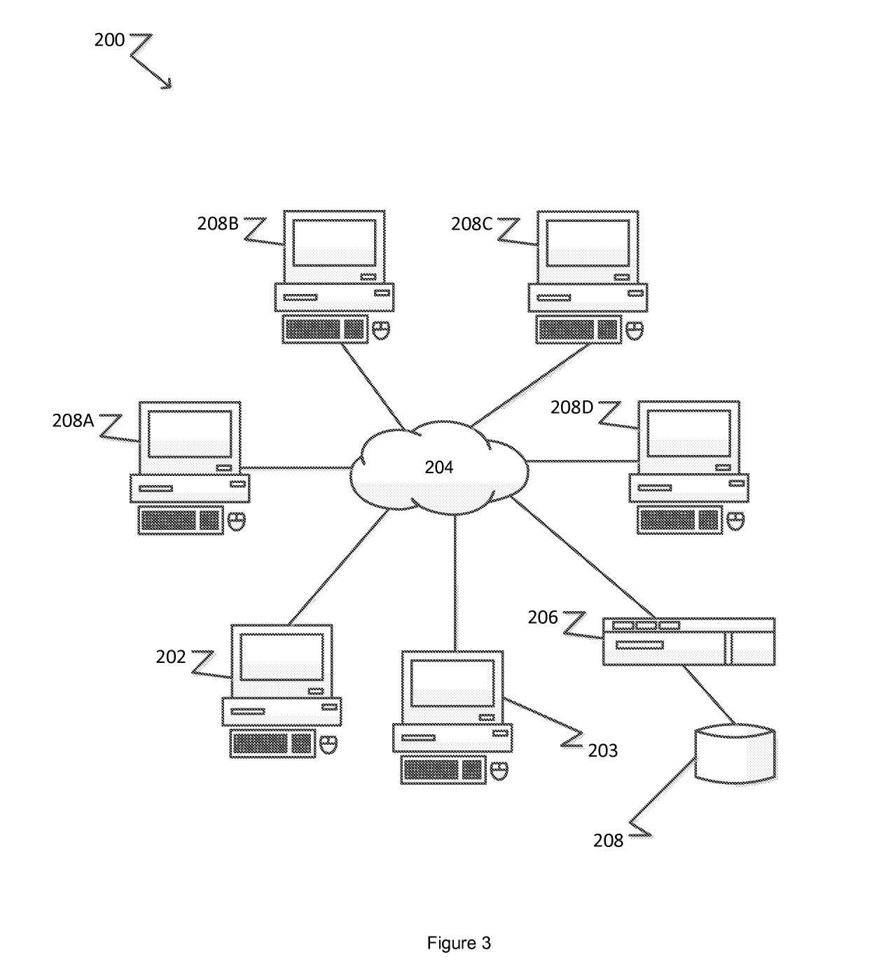

### DESCRIPTION

Throughout the following description, specific details are set forth in order to provide a more thorough understanding of the invention. For example, for the purposes of illustration, the invention is disclosed herein as applied to the context of scheduling matches for an amateur hockey league. However, the disclosure of the invention in this context should not be interpreted as implying limitations on potential fields where aspects of the invention can be beneficially applied. The invention may be practiced without the particulars disclosed herein. In other instances, well known elements have not been shown or described in detail to avoid unnecessarily obscuring the invention. Accordingly, the specification and drawings are to be regarded in an illustrative, rather than a restrictive, sense.

The term “computer” as used herein refers to a device, or group of devices, which is capable of performing one or more logical and/or physical operations on data to produce a result. The term “computers” includes servers, desktops, laptops, netbooks, and tablets, as well as handheld devices such as smart phones, portable game consoles, as well as wearable devices such as smart watches and the like.

The term “configured” as used herein mean that the thing “configured” is adapted, designed or modified for a specific purpose. An example of “configuring” in the context of computers is to provide a computer with specific data (which may include instructions) which can be used in performing the specific acts the computer is being “configured” to do. For example, installing media playing software on a computer “configures” that computer to function as a media player, which it does by using the instructions for the media playing software in combination with other inputs, such as an operating system, and various peripherals (e.g., a keyboard, monitor, speakers, etc.).

The invention is generally directed to systems and methods that allow event organizers to incentivize early registration for events to facilitate scheduling of sub-events within the event by allowing event participants, in order of registration, to select and fix sub-event variables preferred by the event participants.

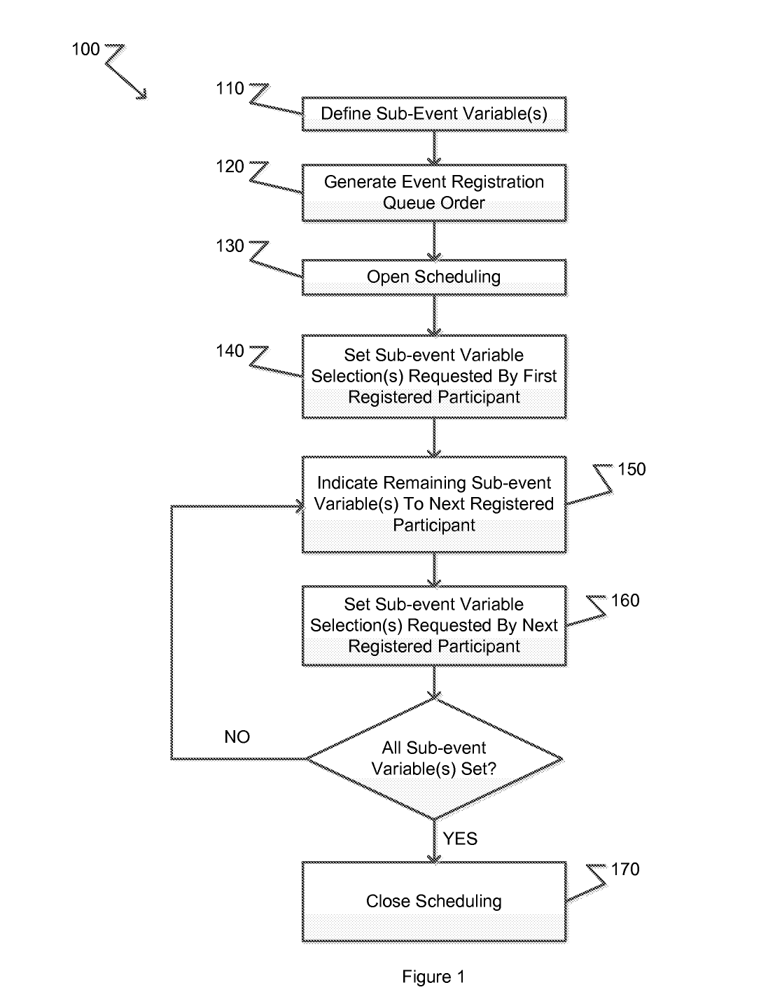

FIG. 1 is a block process diagram of an event scheduling method 100 according to an embodiment of the invention. Method 100 begins with step 110 of defining one or more variables for sub-events within an event.

In some embodiments, an event may be a sports tournament. In some embodiments, an event may be a sports league season. In some embodiments, an event may be any type of competitive or performance event. In some embodiments, an event may be any activity occurring over a period of time (from less than one day, to days, to weeks, to months, or longer) in which there is a common interest in the particular activity among participants.

In some embodiments, a sub-event may be a match within a tournament or league season. In some embodiments, a sub-event may be any discrete occurrence within an event, including but not limited to a race, a performance, a presentation, a lesson, a workshop, a seminar, an interview, and the like.

In some embodiments, a sub-event variable may be any variable regarding the scheduling, logistics or conduct of the sub-events in relation to which an event participant may have a preference.

In an example embodiment, the event may be a minor hockey league tournament, the sub-events may be the individual matches in the tournament, and the sub-event variable is a variable related to the match. For example, the sub-event variable may be one or more of match time, match date, match venue, match officials, match opponent, minimum interval between matches, designated dressing rooms, and the like. The “match time” variable may for example refer to a precise start time, or a range of time within which the match is estimated to occur, or a general time of day (e.g. morning, afternoon, evening) within which the match is estimated to occur. The “match date” variable may for example refer to a particular date, a particular day of the week, weekdays versus weekends, and the like. The “match venue” variable may for example refer to a particular venue, or venues located within a particular geographic area (e.g. venues in City X, or venues within a Y km radius of point Z). The “match officials” variable may refer to available referees, linespersons, timers and/or scorekeepers. The “minimum interval between matches” variable may for example refer to the next match following immediately (but no more than X consecutive matches), at least Y hours later, or at least Z days later.

In some embodiments, additional or alternative variables may be applicable. Non-limiting examples of other sub-event variables include: which team gets the kickoff (e.g. in soccer), which player serves first (e.g. in tennis); which team bats first (e.g. in baseball and cricket); choice of flight/grouping and/or order of a routine/run within a flight (especially in timed activities or activities scored by judges); etc. In some embodiments, the activity may be any competitive activity including non-physical games; for example in chess a sub-event variable could be which player gets the first move. In some embodiments, the activity may be a performance activity; for example in piano recital a sub-event variable could be the order of the pianists' performances. As can be appreciated, the types of sub-event variables can vary widely depending on the activity and its context.

In some embodiments an event scheduler may define one sub-event variable available to be selected by event participants. In the example embodiment of the minor league hockey tournament, a very simple tournament may be a four team round robin tournament played over three days, with one game each in the morning and afternoon of each day. The event scheduler may define the time of day (morning or afternoon) of each of the three matches as the sub-event variable to be selectable by event participants.

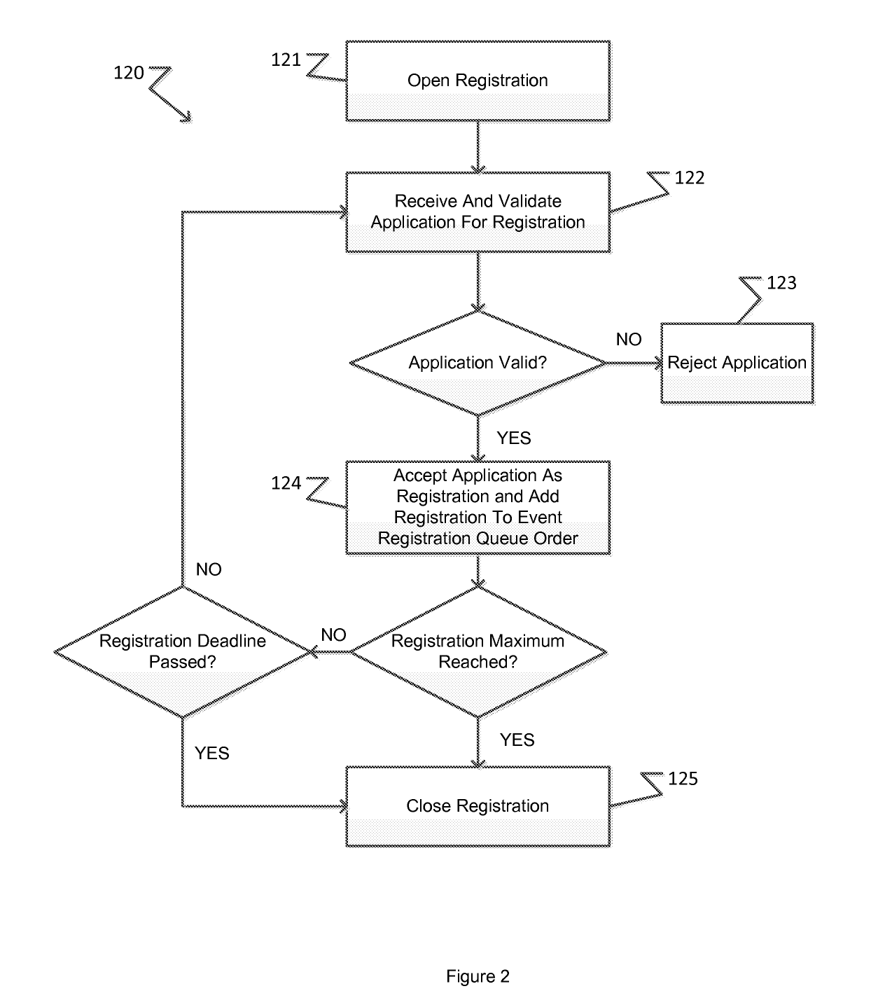

Once the sub-event variables are defined, an event registration queue order is generated at next step 120. FIG. 2 is a block process diagram expanding on the details of step 120 according to an embodiment. Registration is opened at step 121, allowing potential event participants to apply to register for the event. Applications may for example elicit information including the event participant's name (e.g. individual participant name or team participant name), contact information, event category, payment information, and the like. At step 122 the application is received and validated. An application may be invalid due to being incomplete, being a duplicate application, having invalid payment information, and the like. Invalid applications are rejected at step 123. Valid applications are accepted as registrations at step 124, and the registration is added, in temporal order, to an event registration queue order. If the maximum number of registrations has yet to be reached and the registration deadline has not yet passed, then further applications for registrations are accepted at step 122. If the registration maximum has been reached or the registration deadline has passed, then registration is closed at step 125. In the example embodiment of the minor league hockey tournament, registration would close after valid registrations for four teams are accepted. In some embodiments there may be no maximum number of registrations, so registration closes at step 125 at the registration deadline.

Returning to FIG. 1, the schedule is opened at step 130 for filling once at least one registration is entered into the event registration queue order. In some embodiments schedule opens at step 130 once a single registration enters the event registration queue order. In some embodiments schedule opens at step 130 once a predetermined number of registrations enter the event registration queue order. In some embodiments schedule opens at step 130 only after the registration maximum is reached and registration closes at step 125.

After the schedule is opened at step 130, the first event participant according to the event registration queue order is given permission to select one or more sub-event variable(s) of its choice. At step 140 the one or more sub-event variables selected by the first event participant are set. At step 150 the remaining sub-event variables are made available to the second event participant according to the event registration queue order. The second event participant selects one or more of the remaining sub-event variables. At step 160 the one or more sub-event variables selected by the second event participant are set. If at this point there are further sub-event variables available then method 100 goes back to step 140 of indicating the remaining sub-event variables available to the remaining event participants. If there are no further sub-event variables available then scheduling is complete and closed at step 170. In some embodiments one or event participants may decide not to make one or more sub-event variable selections. In these cases, for example, the event scheduler may make the selections on the event participants' behalf, or the selections may be made automatically.

In the example embodiment of the minor league hockey tournament, and with reference to Tables 1a to 1d, the first registered team, Team 1, may for example choose, for each of the three days of the tournament, whether to play in the morning or the afternoon. At step 140, Team 1 may prefer and therefore select to play the morning game for each of the three days of the tournament as shown in Table 1a. At step 150, the remaining match times are made available for choosing by the second registered team, Team 2. In this case, Team 1 could not, for example, choose morning games for all three days, nor afternoon games for all three days since Team 1 has chosen to play all morning games. At step 160 Team 2 would be forced to select afternoon games on two days of its choice (to play against the third and fourth registered teams) and a morning game on one day of its choice (to play against Team 1). In this example, Team 2 chooses to play a morning game on the first day, and afternoon games on the second and third days as shown in Table 1b. Since not all matches are set, step 150 would then be repeated for the third registered team, Team 3, which selects whether to play a morning game on the second day or the third day; the two remaining days must be afternoon games given the selections previously made by Team 1 and Team 2. In this example, Team 3 chooses to play a morning game on the second day, as shown in Table 1c. As shown in Table 1d, by this time since all match times for the fourth registered team, Team 4, have been pre-determined by the selections made by the Teams 1 to 3. Thus with no sub-event variables left for selection, scheduling would close at step 170 without any selections being made available to Team 4 in this example.

TABLE 1a
Exemplary three day round robin tournament selection of
morning/afternoon match time: first round of selection

| | Tournament Day 1 | Tournament Day 2 | Tournament Day 3 |
|---|---|---|---|
| Team 1 | Morning | Morning | Morning |
| Team 2 | | | |
| Team 3 | | | |
| Team 4 | | | |

TABLE 1b
Exemplary three day round robin tournament selection of
morning/afternoon match time: second round of selection

| | Tournament Day 1 | Tournament Day 2 | Tournament Day 3 |
|---|---|---|---|
| Team 1 | Morning | Morning | Morning |
| Team 2 | Morning | Afternoon | Afternoon |
| Team 3 | | | |
| Team 4 | | | |

TABLE 1c
Exemplary three day round robin tournament selection of
morning/afternoon match time: third round of selection

| | Tournament Day 1 | Tournament Day 2 | Tournament Day 3 |
|---|---|---|---|
| Team 1 | Morning | Morning | Morning |
| Team 2 | Morning | Afternoon | Afternoon |
| Team 3 | Afternoon | Morning | Afternoon |
| Team 4 | | | |

TABLE 1d
Example of three day round robin tournament selection
of match time: after third round of selection

| | Tournament Day 1 | Tournament Day 2 | Tournament Day 3 |
|---|---|---|---|
| Team 1 | Morning | Morning | Morning |
| Team 2 | Morning | Afternoon | Afternoon |
| Team 3 | Afternoon | Morning | Afternoon |
| Team 4 | Afternoon | Afternoon | Morning |

Offering event participants the possibility of selecting certain variables regarding the scheduling, logistics or conduct of sub-events in the events, with priority over the selections being determined by the temporal order of registration, creates an incentive for potential event participants to register as early as possible and discourages last-minute registrations.

In performing a method such as method 100, a networked computer system 200 according to an embodiment of the invention could be used. System 200 includes event scheduler computer 202, registrar computer 203, network 204, server 206, and event participant computers 208A, 208B, 208C, 208D.

Registrar computer 203 is configured to allow a registrar to create a registration application. Registrar computer 203 is configured to send the registration application to server 206 through network 204. Server 206 is configured to receive the registration application from registrar computer 203 through network 204.

Event participant computers 208A, 208B, 208C, 208D are configured to allow event participants to complete and send a registration application to server 206 through network 204. The number of event participant computers depends on the number of event participants, so in some embodiments system 200 may have a fewer number of event participant computers while in some embodiments system 200 may have a greater number of event participant computers. Server 206 is configured to receive the completed registration application through network 204 from event participant computers 208A, 208B, 208C, 208D. Server 206 is also configured to determine whether the completed registration application is valid. Server 206 is also configured to an event registration queue order comprising a list of identifiers for event participants with valid completed registration applications. The order of identifiers on the list corresponds to the temporal order of valid completed registration application received by server 206 through network 204.

Event scheduler computer 202 is configured to allow an event scheduler to define sub-event variables. In some embodiments event scheduler computer 202 and registrar computer 203 may be the same computer. Event scheduler computer 202 is configured to send the sub-event variables information to server 206 through network 204. Server 206 is configured to receive the sub-event variables information from event scheduler computer 202 through network 204.

Event participant computers 208A, 208B, 208C, 208D are also configured to allow an event participant to select sub-event variables. Server 206 is configured to receive and record each event participant's selection of sub-event variables in the order of the event registration queue order. Upon recordal of each event participant's selections of sub-event variables, server 206 is configured to automatically update available sub-event variables for selection by the next participant in the registration queue order. If a selection for a particular sub-event variable is not made by an event participant, event scheduler computer 202 and/or server 206 may be configured to automatically make the selection, either manually, randomly, or systematically according to some predetermined algorithm. Server 206 is configured to close registration once all sub-event variables are set.

In some embodiments, steps 140 and 160 of method 100 may include charging event participants a premium fee for selecting particularly desirable sub-event variables. In some embodiments, a premium fee may be charged for selection of all sub-event variables. In some embodiments, different types of sub-event variables may be offered, and a premium fee may be charged only for certain types of sub-event variables. For example, a premium fee may be charged for the privilege of specifying date/time slots of matches. In some embodiments, different types of sub-event variables may be offered, and different premium fees may be charged only depending on the type of sub-event variable. For example, a premium fee may be charged for the privilege of specifying date/time slots of matches, and a lower premium fee may be charged for the privilege of selecting a particular team to play. In some embodiments, premium fees of different amounts may be charged depending on the desirability of a certain sub-event variable selected within a certain type of sub-event variables. For example, a premium fee may be charged for selecting Friday evenings or weekends time/date slots, while lower or no premium fees may be charged for other less desirable time/date slots. In some embodiments, the same premium fee may be charged regardless of the sub-event variable, or type of sub-event variable, selected.

In such embodiments, event scheduler computer 202 is configured to send information associating premium fees with certain sub-event variables and/or or certain types of sub-event variables, to server 206 through network 204, and server 206 is configured to receive such information. Server 206 is configured to display those premium fees with their associated sub-event variables and/or associated types of sub-event variables to event participant computers 208A, 208B, 208C, 208D through network 204. Event participant computers 208A, 208B, 208C, 208D are configured to allow an event participant to select sub-event variables associated with premium fees (and/or sub-event variables without premium fees) and send this information to server 206 through network 204. Based on selections of sub-event variables received, server 206 is configured to automatically update so that only open sub-event variables in the event schedule are made available for selection by the next participant in the registration queue order. If sub-event variables associated with premium fees are selected, this information may be sent directly from event participant computers 208A, 208B, 208C, 208D to registrar computer 203 for processing payment. In some embodiments registrar computer 203 may be configured to process payment of premium fees using the same payment information provided during registration.

In some embodiments, step 120 of creating the event registration queue order of method 100 may be conducted in a different manner than the rest of method 100. For example, registration may conducted manually by phone, mail, and/or in-person.

In such embodiments, registrar computer 203 may be configured to create an event registration queue order based on manual input from the registrar, and to send the event registration queue order to server 206.

In some embodiments, method 100 may allow steps 130 of opening scheduling and subsequent steps to proceed before step 120 of event registration queue order is complete. For example, the first event participant may begin selecting sub-event variables after its registration is validated at step 124 and before the registration maximum is reached.

In some embodiments, method 100 may comprise setting a time limit for event participants to make its sub-event variable selections before the next event participant is permitted make its selections. If the current registered participation does not make a selection within the time limit, then the next event participant is also permitted to make its selection as well. Likewise, if the next event participant does not make its selection within the time limit then the subsequent event participant is also permitted to make its selection, and so on. When a selection is made by any one of a plurality of event participants permitted to make a selection at any given point in time, the available sub-event variables are updated and presented to the other event participants still considering their selections.

In such embodiments, server 206 is configured to receive from the event participant computer of the next event participant in the event registration queue order the next event participant's selection of sub-event variables if the current event participant does not make its selection within a time limit. Server 206 is also configured to receive from the event participant computer of the subsequent event participant in the event registration queue order the subsequent event participant's selection of sub-event variables if the next event participant does not make its selection within the time period, and so on. Server 206 is also configured to update the available sub-event variables as selections are made through the event participant computers by any one of the event participants permitted to make a selection at any given point in time, and to display the updated sub-event variables to the remaining event participant computers of the other event participants still considering their selections. For example, the time limit may be one hour, 30 minutes, 15 minutes, or 5 minutes.

Depending on format of the tournament or league, not all of the matches may have a corresponding sub-event variable. In some embodiments, the format of the tournament or league may be a round robin format (e.g. single round robin, double round robin), an elimination format (single elimination, double elimination, consolation), or a combination of both formats. In a round robin tournament, sub-event variables may be created for up to all of the matches in some embodiments. In an elimination tournament, sub-event variables may only be created for the first round of the tournament in some embodiments since whether a participant will progress to the next round would not be known.

In some embodiments, method 100 may include, at for example step 150, identifying which sub-event variable selections were made which event participants to later event participants that have not yet made their sub-event variable selections. Such information may be useful for the later event participants. For example, in the example embodiment discussed in relation to Tables 1a to 1d, Team 2 and Team 3 can choose the days on which they play particular opponents if their opponents' selections were revealed.

In such embodiments, server 206 is configured to send information linking particular sub-event variable selections to particular event participants to event participant computers 208A, 208B, 208C, 208D through network 204 for display on those computers. In some embodiments, method 100 may include, at for example step 150, revealing only that particular sub-event variables are no longer available, without revealing the identity of the event participants that made those selections, until after all sub-event variables have been set. In such embodiments, server 206 is configured to send information regarding available sub-event variable selections to event participant computers 208A, 208B, 208C, 208D through network 204 for display on those computers.

In some embodiments, method 100 includes providing the option for an event participant that has already made a sub-event variable selection to later change its selection. For example, to make the change the event participant may be queued immediately after the current event participant in the process of making its sub-event variable selection, or may be queued after the last event participant in the event registration queue order. Method 100 also includes determining whether the requested change is possible in view of the remaining sub-event variables at the time of the event participant's turn to change its selection; if the change is possible then the selection change is set, and if the change is not possible then the selection change is rejected.

In such embodiments, event participant computers 208A, 208B, 208C, 208D are configured to send, and server 206 is configured to receive, a sub-event variable selection change through network 204. Server 206 is configured to determine whether the selection change is possible in view of the remaining sub-event variables. Server 206 is configured to either accept or reject the selection change and communicate this decision to the event participant through network 204.

In some embodiments, method 100 includes an initial step of setting an event schedule. This may be practical, for example, for an event where the number, times, dates and venues of the sub-events are predetermined. The key sub-event variable would therefore simply be the identity of the event participant that fills each time/date/venue slot.

In some embodiments, method 100 does not include an initial step of setting an event schedule. This may be practical, for example, where one or more of the number, times, dates and venues of the sub-events have yet to be determined. In the absence of an event schedule, sub-event variables could for example include preferred times, dates and venues of the sub-events. In some embodiments, allowance may be made for event participants to provide a plurality of selections, ordered by preference, for each sub-event variable. Method 100 could thus include a penultimate step of creating an event schedule based on weighted priorities of event participants (based on the event registration queue order) and weight priorities of sub-event variable selections (based on the event participants' order of preference).

In some embodiments, method 100 may include, at step 110, defining access rights for one or more sub-event variables, and between step 130 and step 140 and at step 150, indicating sub-event variables available to the event participant based on the access rights of that event participant. In some embodiments, a returning event participant (i.e., an event participant that had also registered in a previous event) may be permitted to select sub-event variables that are not made available for selection to a new event participant (i.e., an event participant participating in the event for the first time). In some embodiments, an event participant who chooses to pay a premium fee may be permitted to select sub-event variables that are not made available for selection to an event participant who chooses not to pay the premium fee.

In such embodiments, one or more of event scheduler computer 202, registrar computer 203 and server 206 are configured to define access rights of event participants. In some embodiments, access rights may be based on criteria such as the event participant's previous event participation history, premium fee payment, ranking, skill category, age category, sex, and the like. Server 206 is configured to base the sub-event variables to be displayed on event participant computers 208A, 208B, 208C, 208D on the access right of the particular event participant. For example:
server 206 may be connected to a database 208 which stores previous event participation histories. Server 206 may then retrieve such histories from database 208 to define the access rights of event participants. If the event participant has participated in past events then that participant may be given a wider selection of sub-event variables than a participant that has not participated in past events.
server 206 may be configured to query registrar computer 203 to determine whether an event participant has paid a premium fee to gain a wider or more preferred selection of sub-event variables in order to define the access right of that event participant.
server 206 may be configured to query registrar computer 203 to determine the age category of an event participant, in order to define appropriate access rights for the event participant. For example, a tournament might hold matches for teams of different age categories, and in such a case an event participant's access rights may be limited to sub-event variables relating to matches for the event participant's age category.

This application is intended to cover any variations, uses, or adaptations of the invention using its general principles. Further, this application is intended to cover such departures from the present disclosure as come within known or customary practice in the art to which this invention pertains and which fall within the limits of the appended claims. Accordingly, the scope of the claims should not be limited by the preferred embodiments set forth in the description, but should be given the broadest interpretation consistent with the description as a whole.

1. A system comprising:
a. a server configured to:
i. send a registration application for an event to an event participant computer upon receiving a request from the event participant computer;
ii. determine whether a completed registration application received from the event participant computer is valid;
iii. generate an event registration queue order comprising a list of identifiers for event participants with valid completed registration applications, in temporal order of receipt of the completed registration application;
iv. record selected sub-event variables of each event participant in the order of the event registration queue order;
v. automatically update available sub-event variables to the next event participant in the event registration queue order after recordal of each event participant's selected sub-event variables;
b. a plurality of event participant computers configured to:
i. allow event participants to complete and send the registration applications to the server;
ii. allow the event participants to select sub-event variables;
c. an event scheduler computer configured to:
i. allow an event scheduler to define and send sub-event variables to the server.

2. A system according to claim 1 comprising:
a. a registrar computer configured to:
i. allow a registrar to create and send the registration application to the server.

3. A system according to claim 2 wherein the event scheduler computer or the registrar computer is further configured to allow the event scheduler or registrar to associate a premium fee with a sub-event variable, and to send information associating the premium fee with the sub-event variable to the server; wherein the server is configured to send information associating the premium fee with the sub-event variable to the event participant computer; wherein the plurality of event participant computers are configured to allow the event participants to select the sub-event variable associated with the premium fee; and wherein the server is configured to record the selected sub-event variable associated the premium fee.

4. A system according to claim 3 wherein the event scheduler computer or the registrar computer is further configured to allow the event scheduler or registrar to associate a first premium fee with a first sub-event variable, and a second premium fee with a second sub-event variable, wherein the first premium fee and the second premium fee are not equal.

5. A system according to claim 1 wherein the registrar computer and the event scheduler computer are the same computer.

6. A system according to claim 1 wherein the server is configured to receive from the event participant computer of a next event participant in the event registration queue order the next event participant's selection of the sub-event variable if the a current event participant does not make the current event participant's selection of the sub-event variable within a predetermined time limit.

7. A system according to claim 1 wherein the server is configured to send information identifying sub-event variable selections made by event participants to the event participant computer of event participants yet to make sub-event variable selections.

8. A system according to claim 1 wherein the server is configured to block information identifying sub-event variable selections made by event participants from being sent to event participant computers of event participants yet to make sub-event variable selections.

9. A system according to claim 1 wherein the event participant computer is configured to allow a sub-event variable selection change to the server, wherein server is configured to receive the sub-event variable selection change from the event participant computer and to either accept or reject the sub-event variable selection change based on whether the sub-event variable selection change is possible in view of the remaining sub-event variables.

10. A system according to claim 2 wherein one or more of the event scheduler computer, the registrar computer and the server are configured to define access rights of event participants, and wherein the server is configured to base the sub-event variables to displayed on the event participant computers on the access right of a particular event participant.

11. A system according to claim 10 wherein the event scheduler computer, the registrar computer and the server are configured to define the access rights of event participants based on or more of the event participant's previous event participation history, premium fee payment, ranking, skill category, age category and sex.
